(19) United States
(12) Patent Application Publication
(10) Pub. No.: US 2020/0269133 A1
(43) Pub. Date: Aug. 27, 2020

(54) GAME AND SCREEN MEDIA CONTENT STREAMING ARCHITECTURE

(71) Applicant: INTEL CORPORATION, Santa Clara, CA (US)

(72) Inventors: MinZhi SUN, Bellevue, WA (US); Changliang WANG, Bellevue, WA (US)

(73) Assignee: INTEL CORPORATION, Santa Clara, CA (US)

(21) Appl. No.: 16/871,482

(22) Filed: May 11, 2020

(51) Int. Cl. A63F 13/355; A63F 13/50

(52) U.S. Cl. CPC A63F 13/355; A63F 13/50

(57) ABSTRACT

A streaming architecture includes a two-layer architecture with a base layer and an enhanced layer. The base layer encodes computer generated content and generates an encoded bitstream. The enhanced layer encodes and transmit a chroma residual for a region of interest, wherein the encoded chroma residual stored in a UV33 surface that is inserted into a supplemental enhancement information (SEI) of the encoded bitstream from the base layer. A transmitter transmits the encoded bitstream to a receiver.

### BACKGROUND

When streaming media content, the content may be subject to chroma subsampling prior to rendering. For example, when streaming gaming content, the content is often down sampled, transmitted, and then up sampled. The application of chroma subsampling can distort the final, rendered media content.

### BRIEF DESCRIPTION OF THE DRAWINGS

FIG. 1 is a block diagram illustrating a system for a media content streaming architecture;

FIG. 2 is an illustration of deriving the layout of a UV33 surface from a YUV 4:4:4 surface and a down sampled YUV 4:2:0 surface for a chroma sample type of 0 or 2;

FIG. 3 is an illustration of layouts of a UV33 surface for chroma sample types 1, 3, 4, and 5;

FIG. 4 is a process flow diagram of a method for decoding media content encoded using a two-layer streaming architecture;

FIG. 5 is a process flow diagram of a method that provides a streaming architecture for media content according to the present techniques;

FIG. 6 is a block diagram illustrating an example computing device that can provide a streaming architecture for media content; and

FIG. 7 is a block diagram showing computer readable media that store code for a media content streaming architecture.

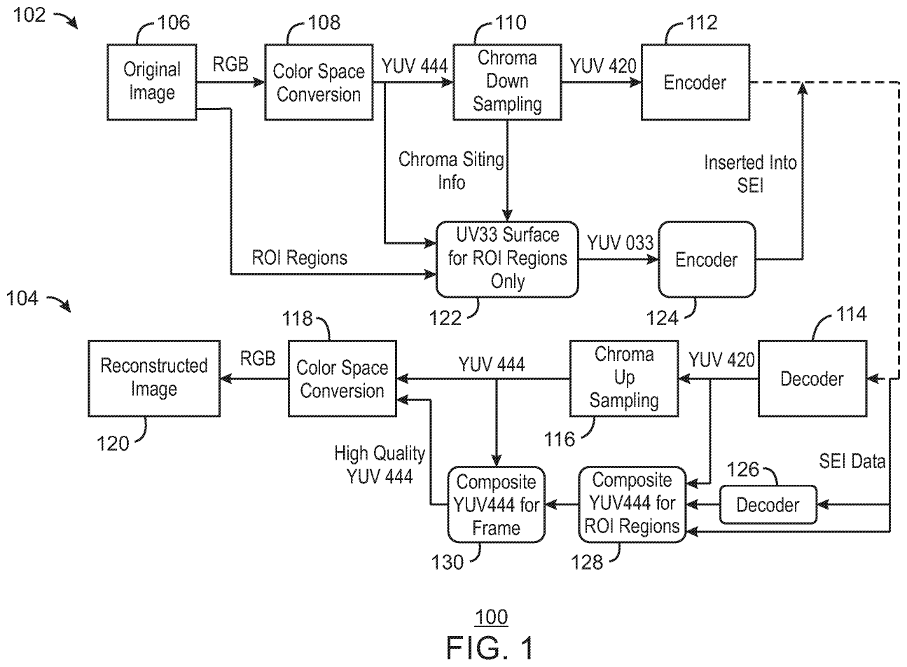

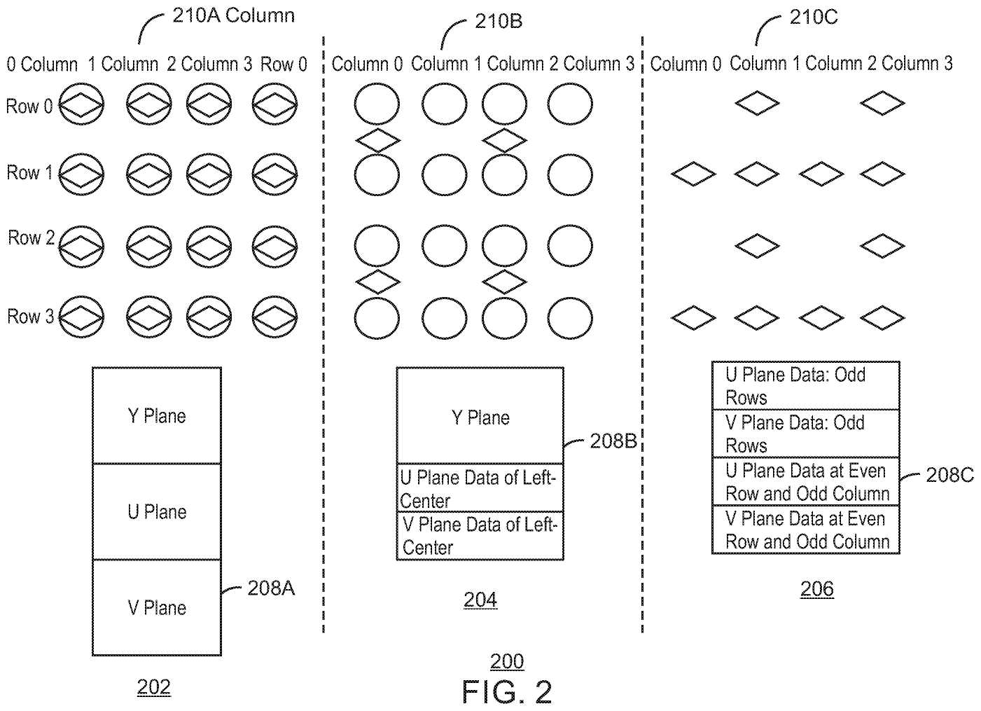

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Pixel values are often specified using chrominance (chroma) information and luminance (luma) information. Chroma subsampling encodes images using less resolution for the chroma information than for the luma information. Chroma subsampling leverages the human visual system's lower acuity for differences in chrominance than for differences in luminance. A streaming architecture can be optimized by selectively devoting more bandwidth to representing the luma component when compared to the chroma components. In some cases, this format of pixel value representation may be referred to as a planar format, where a luma value and two chroma values are stored in three separate planes.

The luma component is often denoted as Y, while the chroma components are denoted as U and V. The particular form of chroma subsampling is commonly expressed as a three-part ratio “A:B:C” that describes the number of luminance and chrominance samples in a conceptual region that is A pixels wide, and two pixels high. The three-part ratio A:B:C may be used to describe how often the chroma components (U and V) are sampled relative to the luma component (Y). The “A” portion of the ratio represents a horizontal sampling reference, or the width of the conceptual region. Typically, “A” is four (4). The “B” portion of the ratio represents the number of chrominance samples (U and V) in the first row of “A” pixels. The “C” portion of the ratio represents the number of changes of chrominance samples between first and second row of “A” pixels.

For example, in a 4:4:4 chroma subsampling ratio, each of the three components have the same sample rate, thus there is no chroma subsampling. The original, unsampled image in a Red, Green, Blue (RGB) format may be converted to a YUV color space and is referred to as being in a 4:4:4 format. For a 4:2:0 chroma subsampling ratio, the horizontal color resolution is halved, but as the U and V channels are only sampled on each alternate line, the vertical resolution is halved. Typically, U and V are each subsampled at a factor of two both horizontally and vertically. The 4:2:0 chroma subsampling is a popular chroma format supported by many video codec standards, as this particular chroma subsampling ratio can reduce bits consumed by the chroma plane during encoding, which is less sensitive to human eye perception than luma. Streaming content is often down sampled from the original 4:4:4 image to a 4:2:0 image, transmitted to a receiver, and then up sampled back to a 4:4:4 image. This down sampling, transmission, and up sampling can cause a large quality loss in the final up sampled image. In particular, color blur and bleeding may be observed in the streamed content. These distortions may be especially pronounced at colorful text and sharp color edges in the streamed content. Colorful text and sharp color edges often occur in gaming content and screen content.

The present disclosure generally provides a media content streaming architecture. As described herein, the architecture is a two-layer scalable streaming architecture with a base layer and an enhanced layer. The base layer compresses images according to a typical 4:2:0 chroma subsampling ratio. In embodiments, the base layer may be streamed, decoded at a receiver, and rendered in a conventional manner. The enhanced layer encodes and transmit a chroma residual to the receiver. The chroma residual represents a loss from chroma down sampling at source side. Information from the enhanced layer may be used to assist the base layer in reconstructing a 4:4:4 surface at the receiver. In embodiments, the chroma residual is transmitted to the receiver by encapsulating the chroma residual in the supplemental enhancement information (SEI) of the base layer. The chroma residuals are obtained for regions of interest, such as small colorful text, sharp color edges, or any user interested areas. The chroma residuals from the enhanced layer do not require a residual value for the entire image, which saves a large number of bits when transmitting the data across a network. If a receiver does not support processing of the enhanced layer, the base layer functions independently of the enhanced layer to output image information in a conventional format, without causing any reduction in image quality.

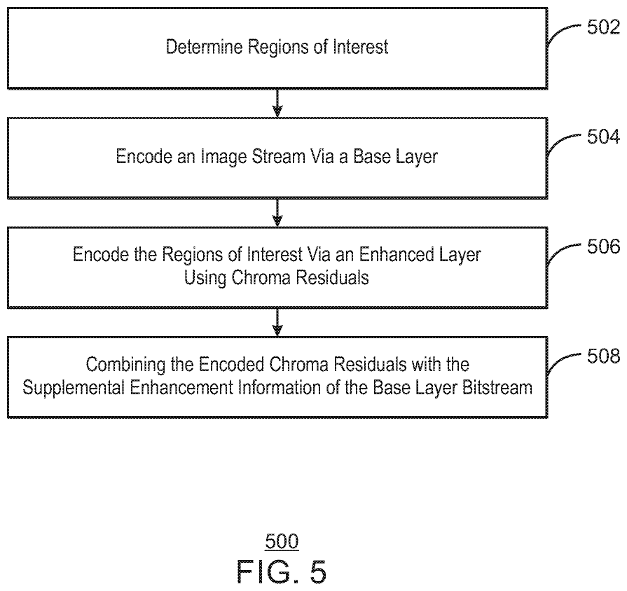

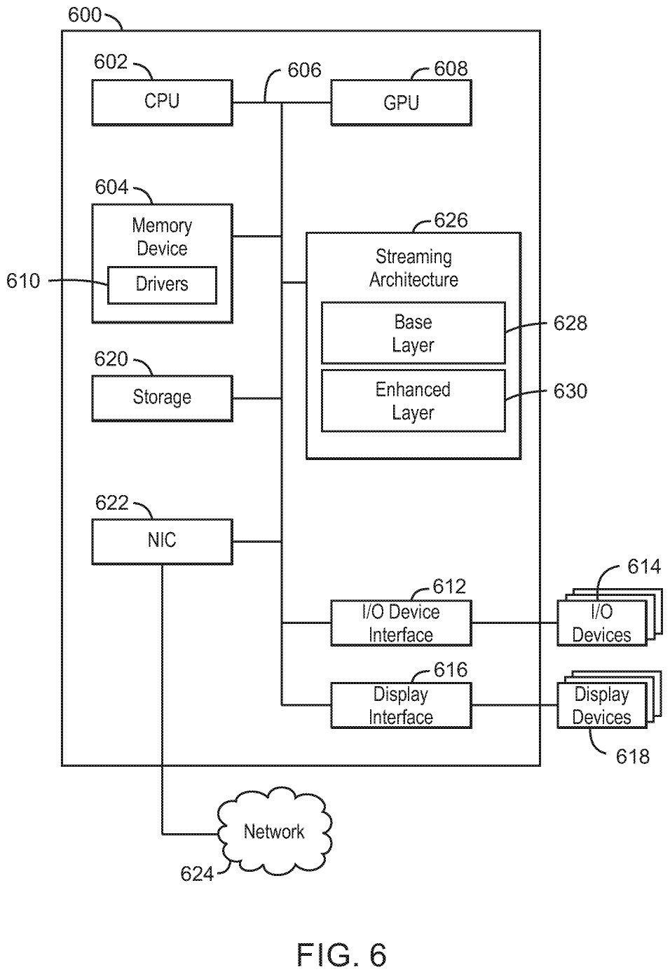

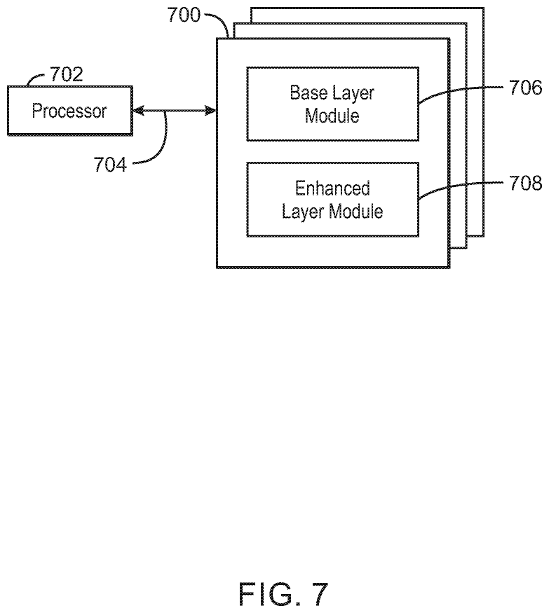

FIG. 1 is a block diagram illustrating a system 100 for a media content streaming architecture. The example system 100 can be implemented by the computing device 700 in FIG. 7 using the method 500 of FIG. 5 and the computer readable medium 600 of FIG. 6.

The architecture 100 includes a source side 102 and a receiver side 104. At the source side 102 the original image 106 is illustrated. The original image 106 includes a plurality of images such as a video to be streamed. The streaming content may be computer generated content. Computer-generated content includes gaming content, which is created for gaming purposes. Computer-generated content also includes screen content. As used herein, screen content generally refers to digitally generated pixels present in images or video. Pixels generated digitally as in computer generated content, in contrast with pixels captured by an imager or camera, may have different properties. In examples, computer generated content includes video containing a significant portion of rendered graphics, text, or animation, rather than camera-captured video scenes. Pixels captured by an imager or camera contain content captured from the real-world, while pixels of screen content or gaming content are generated electronically. Put another way, the original source of computer-generated content is electronic. Computer-generated content is typically composed of fewer colors, simpler shapes, a larger frequency of thin lines, and sharper color transitions when compared to other content, such as natural content.

The original computer-generated content of the original image 106 may be specified using an RGB color model to describe the chromacities of the content. Color space conversion 108 is applied to the original image 106. At the color space conversion 108, the original image 106 specified by an RGB color model is converted into a YUV color space. The YUV color space specifies the image in terms of one luma component and two chrominance components for each pixel of the image. At the color space conversion 108, the image is fully specified by the one luma component and two chrominance components, and is referred to as a YUV 4:4:4 image, where the chroma subsampling ratio of the content is 4:4:4.

At chroma down sampling 110, the converted image is down sampled. Streaming architectures can leverage limitations of human visual perception and reduce bandwidth needed to stream content by allocating more bandwidth for luminance information than chrominance information. In the example of FIG. 1, the chroma down sampling 110 down samples the image information to a chroma subsampling ratio of 4:2:0. The particular chroma subsampling ratios described herein are for exemplary purposes only and should not be viewed as limiting on the techniques described herein. In embodiments, the chroma down sampling 110 may down sample the fully specified image data using any reduced chroma subsampling ratio.

Many video coding standards specify down sampling to a 4:2:0 image when processing media content. Compression/encoding may also be used when preparing the video stream for transmission between devices or components of computing devices. Video compression may be performed according to various standards, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, as well as extensions of such standards. Thus, video encoding standards include hardware-based Advanced Video Coding (AVC)-class encoders or High Efficiency Video Coding (HEVC)-class encoders. For example, AVC-class encoders may encode video according to the ISO/IEC 14496-10—MPEG-4 Part 10, Advanced Video Coding Specification, published May 2003. HEVC-class encoders may encode video according to the HEVC/H.265 specification version 4, which was approved as an ITU-T standard on Dec. 22, 2016.

In the example of FIG. 1, after chroma down sampling 110 the image is specified according to the YUV 4:2:0 chroma subsampling ratio. The encoder 112 then encodes the down sampled YUV 4:2:0 image to prepare for transmission to the receiver side 104. At the receiver 104, the decoder 114 receives the encoded image. The decoder 114 decodes the encoded image back to a YUV 4:2:0 image. Chroma up sampling 116 up samples the decoded YUV 4:2:0 image to a YUV 4:4:4 image. After up sampling, the YUV 4:4:4 image is converted to an RGB color model via the color space conversion 118. The color space conversion 118 results in a reconstructed image 120.

The down sampling, transmission, reception, and up sampling described above often results in quality issues near detailed regions in the image, such as colorful text and sharp color edges. These regions may be referred to as regions of interest (ROI). In embodiments, regions of interest may be areas of an image where an abrupt change in pixel values may occur across a few pixels, such as the change in pixels values near text and sharp color edges. The regions of interest may be critical parts of the image, such as interactive text and colorful illustrations as observed in gaming content. Critical parts of the image are those portions of the image that convey an integral concept or information from the image.

To increase the quality of the reconstructed image, the present techniques provide a two-layer (base layer+enhanced layer) scalable architecture for high quality colorful texts and sharp edges in a reconstructed image. As illustrated in the example of FIG. 1, the base layer includes processing the original image 106, color space conversion 108, chroma down sampling 110, encoder 112, decoder 114, chroma up sampling 116, and color space conversion 118 to obtain the reconstructed image 120. In embodiments, this base layer may represent a traditional streaming architecture that suffers from poor quality near regions of interest. The enhanced layer creates a UV33 surface 122 for the regions of interest. The UV33 surface 122 includes chroma residual data from the original YUV 4:4:4 image as input to chroma down sampling 110 of the base layer, but not retained in the YUV 4:2:0 image output by the chroma down sampling 110 at the base layer. Accordingly, for each pixel the chroma residual is the difference in chrominance information between the original image and the down sampled image. In the example of FIG. 1, the chroma residual is the difference in chrominance information between the original YUV 4:4:4 image and the down sampled YUV 4:2:0 image. The enhanced layer in the streaming architecture described herein includes four major components: 1) region of interest determination; 2) construction of a UV33 surface; 3) SEI data organization and insertion to a bitstream; and 4) YUV444 surface composition to restore high-quality chroma data to the final reconstructed image.

The regions of interest may be extracted from the original image 106. In embodiments, the regions of interest may be determined by an algorithm that detects areas that include colorful text or sharp color edges or pre-existing knowledge from a user that identifies the regions of interest. For example, regions of interest may be determined using edge detection, Sobel edge detectors, Canny edge detection, edge thinning, thresholding, or any combination thereof. Additionally, sharp color edge-detection may be performed using machine learning techniques. Creation of the UV33 surface 122 construction takes as input the regions of interest as extracted from the original input image, the corresponding YUV 4:4:4 for the regions of interest, and chroma siting information from the chroma down sampling 110 to create the UV33 surface that includes chroma residual data for each pixel.

Chroma siting refers to the relative position of a chrominance component data position with respect to its set of one or more associated luminance component data positions. During chroma subsampling, such as the chroma down sampling 110, the chroma components are down sampled by selectively removing or dropping color information from the image. For example, each chroma component may be averaged over a defined conceptual region, such as a 2×2 block of pixels. This simple averaging may yield a sampled chroma component effectively located at the center of the 2×2 block of pixels. Video coding standards may specify the particular positions used to derive chrominance samples in accordance with a particular chroma sub-sampling ratio. In particular, video coding standards may specify a chroma sample type that may be used to determine the chroma offsets in the vertical and/or horizontal directions. The chroma sample type may be signaled in the bitstream and are used to derive the particular samples obtained during subsampling.

The UV33 surface contains chroma residuals for pixels of the identified regions of interest and may be specified by a YUV 0:3:3 color space. The YUV 0:3:3 color space is encoded by an encoder 124. The encoded residuals may be inserted or combined into the supplemental enhancement information (SEI) of the base layer. Encoders output a bitstream of information that represents encoded images and associated data. For example, the bitstream may comprise a sequence of network abstraction layer (NAL) units. Each NAL unit may include a NAL unit header and may encapsulate a raw byte sequence payload (RBSP). Different types of NAL units may encapsulate different types of RBSPs. For example, a NAL unit may encapsulate an RBSP for supplemental enhancement information (SEI). In examples, SEI includes information that is not required to decode the encoded samples, such as metadata. An SEI RBSP may contain one or more SEI messages. In embodiments, an SEI message may be a message that contains SEI.

Thus, the encoded chroma residuals are packaged with the base layer information for transmission to a receiver. The encoded chroma residuals are transmitted with the base layer bitstream to the receiver side 104 where they are decoded at the decoder 126. The encoded chroma residuals used to derive a composite 128 for the regions of interest. The composite 128 represents the identified regions of interest in a YUV 4:4:4 format with high quality. The decoded base layer information and the decoded chroma residuals are also used to derive the composite 128. The composite 128 of regions of interest in a YUV 4:4:4 format is used to derive a composite 130 for the entire image or frame. The composite 130 is generated by replacing pixel values of the chroma up sampled image from the base layer with YUV 4:4:4 data from the composite 128. The up sampled base layer information is used to derive the composite 130, and the composite 130 includes high quality YUV 4:4:4 data for each region of interest identified in the original input image. If supported by the receiver, the composite 130 replaces the lower quality up sampled base layer information from the chroma up sampling 116 at the color space conversion 118. In this manner, the reconstructed image can include high quality YUV 4:4:4 data for each region of interest identified if the enhanced layer is supported by the receiver. Otherwise, the reconstructed image is generated using information as captured by the base layer.

The diagram of FIG. 1 is not intended to indicate that the example system 100 is to include all of the components shown in FIG. 1. Rather, the example system 100 can be implemented using fewer or additional components not illustrated in FIG. 1 (e.g., additional components, processes, conversions, coders, etc.).

At the receiver side 104, if the system does not support processing of the enhanced layer, the base layer still functions independently and its output will be final result, which results in no system quality regression or degradation. For example, a system may not support processing of the enhanced layer if the system does not support SEI decoding or surface composition. In this manner, the two-layer streaming architecture creates the best quality for colorful text and sharp color edges by improving visual quality of the rendered output. In embodiments, the chroma peak signal to noise ratio is improved 50% compared to FFmpeg using 20-tap filter for chroma subsampling. The present techniques do not increase network bandwidth as simple 4:4:4 encoding does. The lack of increase in network bandwidth is due to the fact that extra encoding of the chroma residuals is only for regions of interest, which covers only colorful text or sharp edges. If the receiver, such as a client player, does not support this scalable data format images can still be reconstructed by processing base layer data. Conventional techniques such as FFmpeg are unable to increase the quality of small size colorful text and sharp color edges.

The UV surface format (UV33) described herein stores and transmits the chroma residual with the least amount of data to restore a YUV 4:4:4 together with the existing YUV4:2:0 surface. Generally, the particular chroma residual values may vary according to the chroma sample type. Video coding standards may define several chroma sample types that may be used to determine the chroma offsets in the vertical and/or horizontal directions. The chroma sample type may be signaled in the bitstream and is used to derive the particular samples obtained during subsampling.

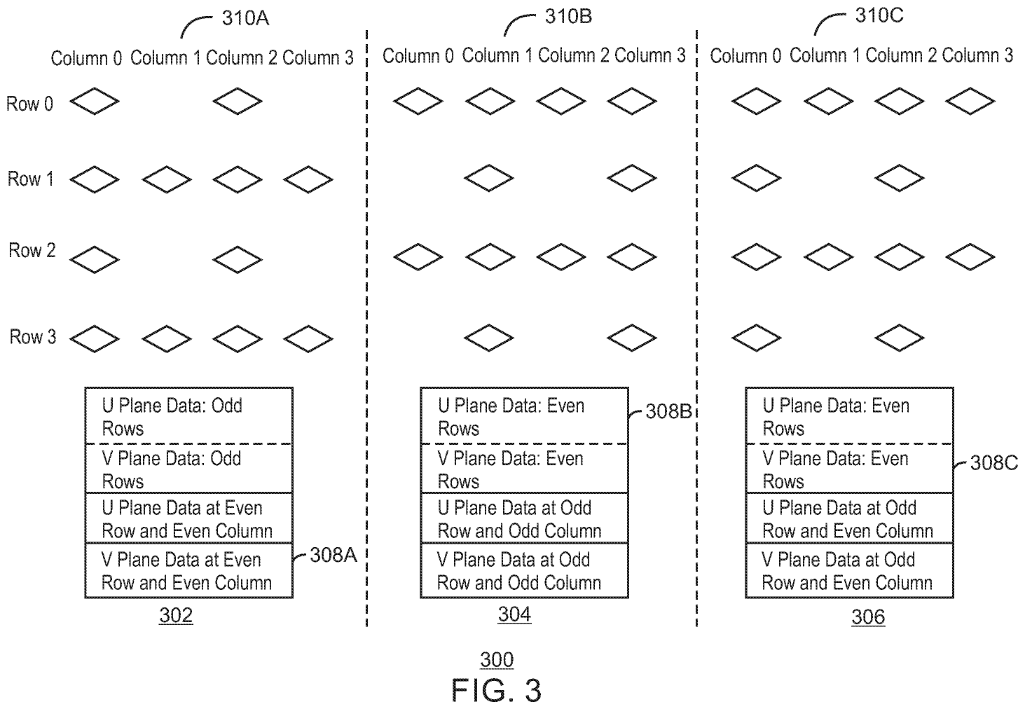

Generally, the UV33 surface is designed to meet two goals: 1) no redundant UV information from the YUV 4:2:0 surface of the base layer; and 2) enough information for the receiver side to reconstruct the YUV 4:4:4 data. The UV33 surface will have a different layout based on different chroma siting location information used during chroma down sampling from YUV 4:4:4 to YUV 4:2:0. For example, the in HEVC specification chroma siting locations are specified in the H.264/H.265 specification Annex E, indicated by “Chroma Sample Type” in bitstream syntax. FIGS. 2 and 3 illustrate a layout for each value of a chroma sample type in the range [0, 5]. The size of the UV33 surface is same as a YUV 4:2:0 surface of the same width and height of pixels. The UV33 surface size at the enhanced layer is much smaller than the YUV 4:2:0 surface at the base layer because it contains only chroma residual data for regions of interest. If a system does not use or follow chroma sitting locations specified by video codec standards, the UV33 surface may be constructed by sending chroma information meeting the two goals described above. Additionally, the present techniques may also be implemented It also works with non-standard encode/decode techniques, as long as the two goals above are met.

FIG. 2 is an illustration of deriving the layout of a UV33 surface 200 from a YUV 4:4:4 surface 202 and a down sampled YUV 4:2:0 surface for a chroma sample type of 0 or 2. For example, in the HEVC coding standard, chroma sample type 0 and 2 specify chroma subsampling locations “left-center” and “top-left,” respectively, when generating YUV 4:2:0 surface 204. In FIG. 2, a 4:4:4 YUV surface 202 is illustrated. Each of the Y plane, U plane, and V plane are represented by the same amount of data as illustrated by the plane 208A. Additionally, the corresponding conceptual region 210A is illustrated using circles to represent luminance information locations and diamonds to represent chrominance information locations. As illustrated by the conceptual region 210A, each location has fully specified luminance and chrominance values.

The surface 204 represents a YUV 4:2:0 chroma subsampling ratio applied to the original input image. In this example, the chroma sample type=0 and chrominance information is sampled at positions offset to the left-center of the luminance information. In embodiments, a chroma subsampling location that is left center (chroma sample type=0) means that when deriving a YUV 4:2:0 surface 204, only the left-center chroma sample from each 2×2 set of chroma data points in a YUV 4:4:4 surface 202 is retained. In another words, when down sampling a YUV 4:4:4 202 surface to YUV 4:2:0 surface 204, for each 2×2 set of chroma data points, one chroma sample in a left-center location is generated and stored in the YUV 4:2:0 surface 204. The plane 208B illustrates the U and V chroma information at half the size of the luma information. In the conceptual region 210B, each chroma sample is represented by a diamond whose location shows the chroma subsampling location when down sampling to YUV 4:2:0. As illustrated, left-center refers to the center of the two left-most data points in a 2×2 set of data points.

The surface 206 represents a derived UV33 surface for chroma sample types 0 and 2. In examples, the UV33 surface 206 represents a residual or difference between the YUV 4:4:4 surface 202 and the YUV4:2:0 surface 204. Accordingly, the layout of the surface 206 may be derived by subtracting the YUV 4:2:0 surface 204 from the YUV 4:4:4 surface 202. For each odd row (counting from 0), the chroma residual data is exactly the same as the row of chroma values in the YUV 4:4:4 surface 202. For each even row, the chroma residual data is from the same row of chroma values in YUV 4:4:4 surface 202. However, the number of data points is half of that of the surface 202, as the other half of the chroma residual data already exists or is retained by the YUV 4:2:0 surface 204. Similarly, chroma residual data at odd columns in the surface 202 are stored at the UV33 surface 206. The chroma residual data at even columns in the UV33 surface 206 is half of that of the surface 202, as the other half of the chroma residual data already exists or is retained by the YUV 4:2:0 surface 204. As illustrated in the conceptual region 210C, diamonds illustrate chroma residual data.

FIG. 3 is an illustration of layouts of a UV33 surface for chroma sample types 1, 3, 4, and 5. Deriving the surface 302, surface 304, and surface 306 is similar to deriving surface 206 as explained with respect for FIG. 2. For example, an HEVC coding standard, chroma sample types 1 and 3 indicate chroma subsampling locations that are “right-center” and “top-right,” respectively, when down sampling to a YUV 4:2:0. For each of chroma sample types 1 and 3, the chroma values in even columns of the YUV4:4:4 surface 202 (FIG. 2) are not retained by the down sampled YUV 4:2:0 surface. As a result, all even columns of chroma data are stored by the UV33 surface 302 as chroma residual data. For odd columns in chroma sample types 1 and 3, either an even or odd row of chroma values of the same column from the YUV 4:4:4 surface 202 (FIG. 2) can be retained as chroma residual data. In the example of UV surface 302, chroma data from odd rows is retained. In embodiments, for chroma sample types 1 and 3 either even or odd rows of chroma values of the same column from the YUV 4:4:4 surface 202 (FIG. 2) can be used to derive the entire odd column chroma data from the chroma residual values and YUV 4:2:0 surface 202 (FIG. 2). In the conceptual region 310A, diamonds illustrate the layout of chroma residual data relative to a YUV 4:4:4 surface layout.

The surface 304 represents a UV33 surface for chroma sample type 4. In the HEVC coding standard, chroma sample type 4 indicates a chroma subsampling location that is “left-bottom” when down sampling to YUV 4:2:0. The odd columns of chroma values from the YUV 4:4:4 surface 202 (FIG. 2) are not retained by the YUV 4:2:0 surface 204 (FIG. 2) when down sampling. Accordingly, the odd columns of chroma values from the YUV 4:4:4 surface 202 (FIG. 2) are stored in the UV33 surface 304 as chroma residual data. For even columns, either an even or odd row of chroma values of the same column of the YUV 4:4:4 surface 202 (FIG. 2) can be retained as chroma residual data. In the example of UV surface 304, chroma data from the even rows is retained. In embodiments, for chroma sample type 4, either even or odd rows of chroma values of the same column from the YUV 4:4:4 surface 202 (FIG. 2) can be used to derive the entire even column chroma data from the chroma residual values and YUV 4:2:0 surface 204 (FIG. 2). In the conceptual region 3108, diamonds illustrate the layout of chroma residual data relative to a YUV 4:4:4 surface layout.

The surface 306 represents a UV33 surface for chroma sample type 5. In the HEVC coding standard, chroma sample type 5 indicates a chroma subsampling location that is “right-bottom” when down sampling to YUV 4:2:0. The even columns of chroma values from the YUV 4:4:4 surface 202 (FIG. 2) are not retained by the YUV 4:2:0 surface 204 (FIG. 2) when down sampling. Accordingly, the even columns of chroma values from the YUV 4:4:4 surface 202 (FIG. 2) are stored in the UV33 surface 306 as chroma residual data. For odd columns, either even or odd row of chroma values of the same column from the YUV 4:4:4 surface 202 (FIG. 2) can retained as chroma residual data. In the example of UV surface 306, chroma data from the even rows is retained. In embodiments, for chroma sample type 5, either even or odd rows of chroma values of the same column from the YUV 4:4:4 surface 202 (FIG. 2) can be used to derive the entire even column chroma data from the chroma residual values and the YUV 4:2:0 204 (FIG. 2). In the conceptual region 310C, diamonds illustrate the layout of chroma residual data relative to a YUV 4:4:4 surface layout.

Once the UV33 surface is obtained according to the chroma sample type, the encoder of enhanced layer will compress the UV residual with same configuration as base layer encoder except the values of width and height. The compressed UV33 data and region of interest information is transmitted to receiver side together with the bitstream of base layer. In embodiments, the compressed UV33 data and region of interest information is packaged in the SEI part of base layer's bitstream. For example, an HEVC coding standard may specify the particular types of SEI messages for every frame. For example, the nal_unit_type=40(SUFFIX_SEI_NUT) may be packaged with the reserved_sei_message (payloadType>181). Table 1 defines syntax for the regions of interest and the UV residual compressed information. Thus, Table 1 identifies the SEI information design.

TABLE 1

| | |
|---|---|
| enable_uv_residual_compression | 1bit |
| if (enable_uv_residual_compression){ | |

| | |
|---|---|
| num_roi_regions | 7bit |
| if (num_roi_regions != 0) { | |

for(i = 0; i < num_roi_regions; i++) {

| | |
|---|---|
| roi_region_topleft_x | 16bit |
| roi_region_topleft_y | 16bit |
| roi_region_width | 16bit |
| roi_region_height | 16bit |
| roi_region_bitsream_size | 32bit |
| roi_region_bitstream_data( ) | |

}

}

}

The HEVC standard describes the syntax and semantics for various types of SEI messages. However, the HEVC standard does not describe the handling of the SEI messages because the SEI messages do not affect the normative decoding process. One reason to have SEI messages in the HEVC standard is to enable supplemental data being interpreted identically in different systems using HEVC. Specifications and systems using HEVC may require video encoders to generate certain SEI messages or may define specific handling of particular types of received SEI messages.

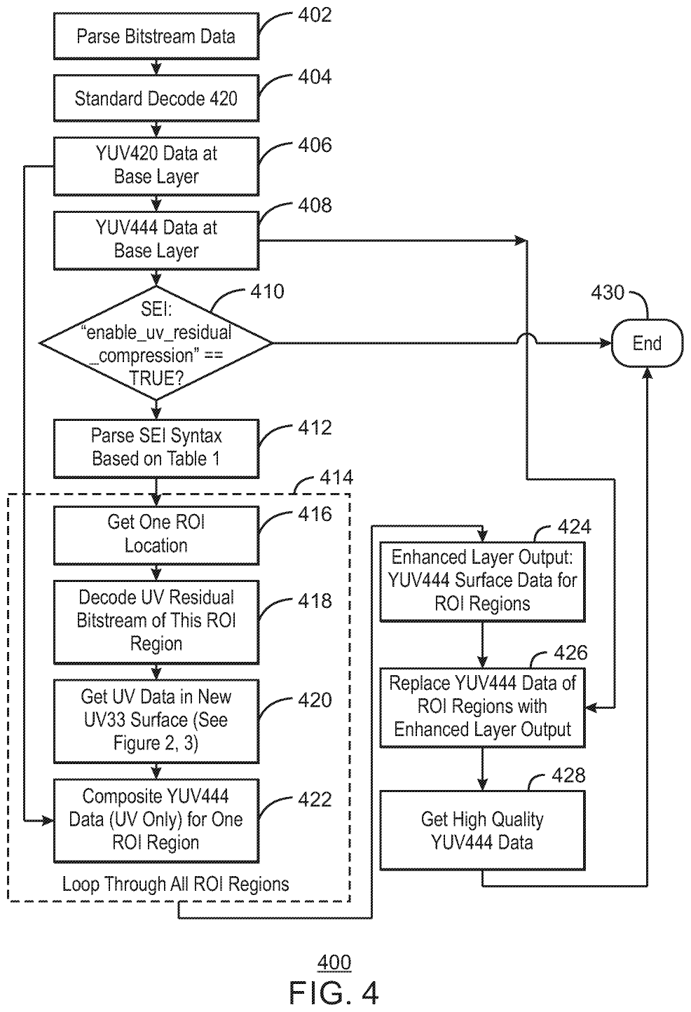

FIG. 4 is a process flow diagram of a method for decoding media content encoded using the two-layer streaming architecture. Generally, YUV 4:4:4 surface composition is the final task of the enhanced layer during decode. Decoding at the enhanced layer includes generating composite YUV 4:4:4 data for each region of interest and generating composite YUV 4:4:4 data for each frame. In embodiments, full resolution chroma data composition for each region of interest is an inverse operation of constructing the UV33 surface as illustrated in FIGS. 2 and 3. In particular, the UV33 surface has three locations of UV data out of each four locations (2 horizontal, 2 vertical). The UV data for the remaining locations may be directly obtained, for example, in the case of chroma sample types 2, 3, 4, or 5 as discussed above. The UV location of the remaining locations may be derived, for example, in the case of chroma sample types 0 and 1, from the base layer YUV 4:2:0 surface data.

At block 402, the received bitstream data is parsed. At block 404, the parsed bitstream data is decoded into a YUV 4:2:0 chroma subsampling ratio. At block 406, the YUV 4:2:0 base layer data is extracted. The YUV 4:2:0 base layer data is converted to YUV 4:4:4 data at block 408. At block 410, it is determined if the receiver supports SEI messaging. If the receiver supports SEI messaging and an “enable UV residual compression” flag is set to “true” after parsing the SEI syntax process flow continues to block 412. Otherwise, if the receiver does not support SEI messaging or an “enable UV residual compression” flag is set to “false” after parsing the SEI syntax, process flow continues to block 430 where the process ends. To determine if the receiver supports SEI messaging it may be determined if an enable UV residual compression flag is set at true.

At block 412, the received SEI syntax is parsed. In examples, the SEI syntax may be parsed based on the information indicated in Table 1. Block 414 indicates processes completed in a loop fashion for all regions of interest. At block 416, one region of interest location is obtained. At block 418, the UV residual bitstream for the obtained region of interest location is decoded. At block 420, the corresponding UV data is extracted from the UV33 surface. At block 422, the YUV 4:4 data is composited for the one region of interest with the YUV 4:2:0 data from base layer from block 406. In embodiments, blocks 416, 418, 420, and 422 are iteratively repeated for each region of interest location until all regions of interest have been processed for each frame.

At block 424, the YUV 4:4:4 surface data for all regions of interest are composited for a single frame. At block 426, the composited YUV 4:4:4 surface data for all regions of interest replaces the YUV 4:4:4 data in the decoded base layer. At block 428 high quality YUV 4:4:4 data for the entire frame is obtained. Process flow ends at block 430.

This process flow diagram is not intended to indicate that the blocks of the example method 300 are to be executed in any particular order, or that all of the blocks are to be included in every case. Further, any number of additional blocks not shown may be included within the example method 300, depending on the details of the specific implementation.

As described according to the present techniques, chroma residual data, focused on regions of interest identified in the original input image are encoded with same encoder as base layer. The encoded chroma residual data is inserted into SEI part of base layer bitstream together with ROI region information, and stream across a network. At receiver side, the enhanced layer receives chroma residual data for the regions of interest after decoding. The decoded chroma residual data is used to composite a YUV 4:4:4 surface, which includes full chroma resolution for each ROI region. A high quality YUV 4:4:4 surface for each frame is constructed by replacing data in ROI region with data from enhanced layer.

To illustrate the advantages of the present techniques, the visual quality of the present techniques may be compared with two traditional solutions. The first traditional technique is using only the base layer, with chroma siting as a default “left-center,” and an encoder using libx265 default config with QP=25. The second traditional technique is using only the base layer only, with chroma up and down sampling using ffmpeg best filter—“sin c” 20-tap, encoder using also libx265 default config with QP=25. Table 2 illustrates objective quality data for the two traditional techniques along with the present techniques. The present techniques improve chroma quality from three metrics point of view: PSNR, SSIM and MSSSIM. Chroma PSNR improves 50% vs the second traditional technique.

TABLE 2

| | PSNR-Y | PSNR-U | PSNR-V | SSIM-Y | SSIM-U | SSIM-V | MSSSIM-Y | MSSSIM-U | MSSSIM-V |
|---|---|---|---|---|---|---|---|---|---|
| First Trad. | 41.395 | 30.554 | 21.412 | 0.99991 | 0.99922 | 0.99427 | 1.00000 | 0.99993 | 0.99947 |
| Meth. | | | | | | | | | |
| Second Trad. | 41.395 | 30.905 | 22.175 | 0.99991 | 0.99930 | 0.99525 | 1.00000 | 0.99995 | 0.99966 |
| Meth. | | | | | | | | | |
| Present | 41.395 | 38.480 | 38.686 | 0.99991 | 0.99999 | 0.99989 | 1.00000 | 0.99999 | 1.00000 |

FIG. 5 is a process flow diagram of a method that provides a streaming architecture for media content according to the present techniques. The example method 500 can be implemented in the system 100 of FIG. 1, the computer readable medium 600 of FIG. 6, or the computing device 700 of FIG. 7.

At block 502, the regions of interest in an original image are determined. The regions of interest may be those regions that include colorful texts, sharp edges, or any combination thereof. At block 504, the original image is encoded via a base layer. At block 506, the regions of interest are encoded according to chroma residual values using an enhanced layer. At block 508, encoded chroma residuals for each region of interest is inserted in the supplemental enhancement information of the base layer bitstream. In embodiments, the combined bitstream is transmitted to a receiver for decoding and rendering.

This process flow diagram is not intended to indicate that the blocks of the example method 300 are to be executed in any particular order, or that all of the blocks are to be included in every case. Further, any number of additional blocks not shown may be included within the example method 300, depending on the details of the specific implementation.

Referring now to FIG. 6, a block diagram is shown illustrating an example computing device that can provide a streaming architecture for media content. The computing device 600 may be, for example, a laptop computer, desktop computer, tablet computer, mobile device, or wearable device, among others. In some examples, the computing device 600 may be a video streaming device. The computing device 600 may include a central processing unit (CPU) 602 that is configured to execute stored instructions, as well as a memory device 604 that stores instructions that are executable by the CPU 602. The CPU 602 may be coupled to the memory device 604 by a bus 606. Additionally, the CPU 602 can be a single core processor, a multi-core processor, a computing cluster, or any number of other configurations. Furthermore, the computing device 600 may include more than one CPU 602. In some examples, the CPU 602 may be a system-on-chip (SoC) with a multi-core processor architecture. In some examples, the CPU 602 can be a specialized digital signal processor (DSP) used for image processing. The memory device 604 can include random access memory (RAM), read only memory (ROM), flash memory, or any other suitable memory systems. For example, the memory device 604 may include dynamic random-access memory (DRAM).

The memory device 604 can include random access memory (RAM), read only memory (ROM), flash memory, or any other suitable memory systems. For example, the memory device 604 may include dynamic random-access memory (DRAM).

The computing device 600 may also include a graphics processing unit (GPU) 608. As shown, the CPU 602 may be coupled through the bus 606 to the GPU 608. The GPU 608 may be configured to perform any number of graphics operations within the computing device 600. For example, the GPU 608 may be configured to render or manipulate graphics images, graphics frames, videos, or the like, to be displayed to a user of the computing device 600.

The memory device 604 can include random access memory (RAM), read only memory (ROM), flash memory, or any other suitable memory systems. For example, the memory device 604 may include dynamic random-access memory (DRAM). The memory device 604 may include device drivers 610 that are configured to execute the instructions for training multiple convolutional neural networks to perform sequence independent processing. The device drivers 610 may be software, an application program, application code, or the like.

The CPU 602 may also be connected through the bus 606 to an input/output (I/O) device interface 612 configured to connect the computing device 600 to one or more I/O devices 614. The I/O devices 614 may include, for example, a keyboard and a pointing device, wherein the pointing device may include a touchpad or a touchscreen, among others. The I/O devices 614 may be built-in components of the computing device 600, or may be devices that are externally connected to the computing device 600. In some examples, the memory 604 may be communicatively coupled to I/O devices 614 through direct memory access (DMA).

The CPU 602 may also be linked through the bus 606 to a display interface 616 configured to connect the computing device 600 to a display device 618. The display device 618 may include a display screen that is a built-in component of the computing device 600. The display device 618 may also include a computer monitor, television, or projector, among others, that is internal to or externally connected to the computing device 600.

The computing device 600 also includes a storage device 620. The storage device 620 is a physical memory such as a hard drive, an optical drive, a thumbdrive, an array of drives, a solid-state drive, or any combinations thereof. The storage device 620 may also include remote storage drives.

The computing device 600 may also include a network interface controller (NIC) 622. The NIC 622 may be configured to connect the computing device 600 through the bus 606 to a network 624. The network 624 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 600 further includes a streaming architecture 626. For example, the streaming architecture 626 can be used to encode video computer generated content. The streaming architecture may obtain streaming content that includes computer generated graphics, such as colorful text and sharp edges. Distortion or poor image quality observed in the streaming content may be due to a loss of chroma information during the down sampling from 4:4:4 to 4:2:0 and then up sampling from 4:2:0 to 4:4:4, which occurs when streaming content. The distortions or poor image content may be, for example, color bleeding and color blur. The color bleeding and color blur is often observed around small-size text and sharp color edge which usually exists in game or screen content. As used herein, the streaming content includes but is not limited to, game and screen content.

The streaming architecture 626 can include a base layer 628 and an enhanced layer 630. Accordingly, the architecture is a two-layer scalable streaming architecture. In embodiments, the base layer 628 compresses images according to a typical 4:2:0 chroma subsampling ratio. The base layer may be independently streamed, decoded at a receiver, and rendered at a display. The enhanced layer 630 is to encode and transmit a chroma residual to the receiver. The chroma residual represents the loss from chroma down sampling at source side. Information from the enhanced layer may be used to assist the base layer in reconstructing a 4:4:4 surface at the receiver. In embodiments, the chroma residual is transmitted to the receiver by encapsulating the chroma residual in the supplemental enhancement information (SEI) of the base layer.

The block diagram of FIG. 6 is not intended to indicate that the computing device 600 is to include all of the components shown in FIG. 6. Rather, the computing device 600 can include fewer or additional components not illustrated in FIG. 6, such as additional buffers, additional processors, and the like. The computing device 600 may include any number of additional components not shown in FIG. 6, depending on the details of the specific implementation. Furthermore, any of the functionalities of the base layer 628 and the enhanced layer 630, may be partially, or entirely, implemented in hardware and/or in the processor 602. For example, the functionality may be implemented with an application specific integrated circuit, in logic implemented in the processor 602, or in any other device. In addition, any of the functionalities of the CPU 602 may be partially, or entirely, implemented in hardware and/or in a processor. For example, the functionality of the streaming architecture 626 may be implemented with an application specific integrated circuit, in logic implemented in a processor, in logic implemented in a specialized graphics processing unit such as the GPU 608, or in any other device.

FIG. 7 is a block diagram showing computer readable media 700 that store code for a media content streaming architecture. The computer readable media 700 may be accessed by a processor 702 over a computer bus 704. Furthermore, the computer readable medium 700 may include code configured to direct the processor 702 to perform the methods described herein. In some embodiments, the computer readable media 700 may be non-transitory computer readable media. In some examples, the computer readable media 700 may be storage media.

The various software components discussed herein may be stored on one or more computer readable media 700, as indicated in FIG. 7. For example, a base layer module 706 compresses images according to a typical 4:2:0 chroma subsampling ratio. The base layer may be independently streamed, decoded at a receiver, and rendered at a display. An enhanced layer module 708 is to encode and transmit a chroma residual to the receiver. The chroma residual represents the loss from chroma down sampling at source side. Information from the enhanced layer may be used to assist the base layer in reconstructing a 4:4:4 surface at the receiver. In embodiments, the chroma residual is transmitted to the receiver by encapsulating the chroma residual in the supplemental enhancement information (SEI) of the base layer.

The block diagram of FIG. 7 is not intended to indicate that the computer readable media 700 is to include all of the components shown in FIG. 7. Further, the computer readable media 700 may include any number of additional components not shown in FIG. 7, depending on the details of the specific implementation.

### Examples

Example 1 is a streaming architecture. The streaming architecture includes a base layer, wherein the base layer performs encodes computer generated content and generates an encoded bitstream; an enhanced layer to encode and transmit a chroma residual for a region of interest, wherein the encoded chroma residual stored in a UV33 surface that is inserted into a supplemental enhancement information (SEI) of the encoded bitstream from the base layer; and a transmitter to transmit the encoded bitstream to a receiver.

Example 2 includes the streaming architecture of example 1, including or excluding optional features. In this example, the UV33 surface is formatted to store and transmit the chroma residual with the least amount of data to reconstruct a YUV 4:4:4 surface composited with a decoded YUV 4:2:0 surface.

Example 3 includes the streaming architecture of any one of examples 1 to 2, including or excluding optional features. In this example, the UV33 surface has a different layout based on different chroma siting location information used during chroma down sampling.

Example 4 includes the streaming architecture of any one of examples 1 to 3, including or excluding optional features. In this example, the size of the UV33 surface is same as a YUV 4:2:0 surface with a same width and height of pixels.

Example 5 includes the streaming architecture of any one of examples 1 to 4, including or excluding optional features. In this example, the amount of data stored at the UV33 surface is smaller than the data stored in a YUV 4:2:0 surface of the base layer.

Example 6 includes the streaming architecture of any one of examples 1 to 5, including or excluding optional features. In this example, in response to the receiver not supporting the enhanced layer, the base layer functions independently to reconstruct the encoded bitstream.

Example 7 includes the streaming architecture of any one of examples 1 to 6, including or excluding optional features. In this example, regions of interest are determined by edge detection, Sobel edge detectors, Canny edge detection, edge thinning, thresholding, or any combinations thereof.

Example 8 includes the streaming architecture of any one of examples 1 to 7, including or excluding optional features. In this example, the enhanced layer output is transmitted using an SEI message.

Example 9 includes the streaming architecture of any one of examples 1 to 8, including or excluding optional features. In this example, the receiver receives the encoded bitstream and parses an SEI syntax to obtain composite YUV 4:4:4 data for each region of interest.

Example 10 includes the streaming architecture of any one of examples 1 to 9, including or excluding optional features. In this example, the encoded bitstream is decoded at the receiver into a YUV 4:2:0 format, wherein for each region of interest base layer information is replaced by enhanced layer information.

Example 11 is a method for a media streaming architecture. The method includes determining regions of interest in image data; encoding the image data into a bitstream at a base layer; encoding the regions of interest using a chroma residual of each region of interest at an enhanced layer; combining the encoded chroma residual from the enhanced layer in a supplemental enhancement information of the bitstream of the base layer; and transmitting the bitstream to a receiver.

Example 12 includes the method of example 11, including or excluding optional features. In this example, the regions of interest are encoded using a UV33 surface.

Example 13 includes the method of any one of examples 11 to 12, including or excluding optional features. In this example, the regions of interest are encoded based on a chroma sitting location.

Example 14 includes the method of any one of examples 11 to 13, including or excluding optional features. In this example, the base layer contains all information to restore the bit stream at the receiver in response to the receiver not supporting the enhanced layer.

Example 15 includes the method of any one of examples 11 to 14, including or excluding optional features. In this example, the regions of interest are those regions that include colorful text and sharp edges.

Example 16 includes the method of any one of examples 11 to 15, including or excluding optional features. In this example, the regions of interest are determined by edge detection, Sobel edge detectors, Canny edge detection, edge thinning, thresholding, or any combination thereof.

Example 17 includes the method of any one of examples 11 to 16, including or excluding optional features. In this example, the enhanced layer output is transmitted using an SEI message.

Example 18 includes the method of any one of examples 11 to 17, including or excluding optional features. In this example, the receiver receives the encoded bitstream and parses an SEI syntax to obtain composite YUV 4:4:4 data for each region of interest.

Example 19 includes the method of any one of examples 11 to 18, including or excluding optional features. In this example, the encoded bitstream is decoded at the receiver into a YUV 4:2:0 format, wherein for each region of interest base layer information is replaced by enhanced layer information.

Example 20 includes the method of any one of examples 11 to 19, including or excluding optional features. In this example, the receiver is a playback device.

Example 21 is at least one computer readable medium for encoding video frames having instructions stored therein that. The computer-readable medium includes instructions that direct the processor to determine regions of interest in image data; encode the image data into a bitstream at a base layer; encode the regions of interest using a chroma residual of each region of interest at an enhanced layer; combine the encoded chroma residual from the enhanced layer in a supplemental enhancement information of the bitstream of the base layer; and transmit the bitstream to a receiver.

Example 22 includes the computer-readable medium of example 21, including or excluding optional features. In this example, the regions of interest are encoded using a UV33 surface.

Example 23 includes the computer-readable medium of any one of examples 21 to 22, including or excluding optional features. In this example, the regions of interest are encoded based on a chroma sitting location.

Example 24 includes the computer-readable medium of any one of examples 21 to 23, including or excluding optional features. In this example, the base layer contains all information to restore the bit stream at the receiver in response to the receiver not supporting the enhanced layer.

Example 25 includes the computer-readable medium of any one of examples 21 to 24, including or excluding optional features. In this example, the regions of interest are those regions that include colorful text and sharp edges.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A streaming architecture, comprising:
a base layer, wherein the base layer performs encodes computer generated content and generates an encoded bitstream;
an enhanced layer to encode and transmit a chroma residual for a region of interest, wherein the encoded chroma residual stored in a UV33 surface that is inserted into a supplemental enhancement information (SEI) of the encoded bitstream from the base layer; and
a transmitter to transmit the encoded bitstream to a receiver.

2. The streaming architecture of claim 1, wherein the UV33 surface is formatted to store and transmit the chroma residual with the least amount of data to reconstruct a YUV 4:4:4 surface composited with a decoded YUV 4:2:0 surface.

3. The streaming architecture of claim 1, wherein the UV33 surface has a different layout based on different chroma siting location information used during chroma down sampling.

4. The streaming architecture of claim 1, wherein the size of the UV33 surface is same as a YUV 4:2:0 surface with a same width and height of pixels.

5. The streaming architecture of claim 1, wherein the amount of data stored at the UV33 surface is smaller than the data stored in a YUV 4:2:0 surface of the base layer.

6. The streaming architecture of claim 1, wherein in response to the receiver not supporting the enhanced layer, the base layer functions independently to reconstruct the encoded bitstream.

7. The streaming architecture of claim 1, wherein regions of interest are determined by edge detection, Sobel edge detectors, Canny edge detection, edge thinning, thresholding, or any combinations thereof.

8. The streaming architecture of claim 1, wherein the enhanced layer output is transmitted using an SEI message.

9. The streaming architecture of claim 1, wherein the receiver receives the encoded bitstream and parses an SEI syntax to obtain composite YUV 4:4:4 data for each region of interest.

10. The streaming architecture of claim 1, wherein the encoded bitstream is decoded at the receiver into a YUV 4:2:0 format, wherein for each region of interest base layer information is replaced by enhanced layer information.

11. A method for a media streaming architecture, comprising:
determining regions of interest in image data;
encoding the image data into a bitstream at a base layer;
encoding the regions of interest using a chroma residual of each region of interest at an enhanced layer;
combining the encoded chroma residual from the enhanced layer in a supplemental enhancement information of the bitstream of the base layer; and
transmitting the bitstream to a receiver.

12. The method of claim 11, wherein the regions of interest are encoded using a UV33 surface.

13. The method of claim 11, wherein the regions of interest are encoded based on a chroma sitting location.

14. The method of claim 11, wherein the base layer contains all information to restore the bit stream at the receiver in response to the receiver not supporting the enhanced layer.

15. The method of claim 11, wherein the regions of interest are those regions that include colorful text and sharp edges.

16. The method of claim 11, wherein the regions of interest are determined by edge detection, Sobel edge detectors, Canny edge detection, edge thinning, thresholding, or any combination thereof.

17. The method of claim 11, wherein the enhanced layer output is transmitted using an SEI message.

18. The method of claim 11, wherein the receiver receives the encoded bitstream and parses an SEI syntax to obtain composite YUV 4:4:4 data for each region of interest.

19. The method of claim 11, wherein the encoded bitstream is decoded at the receiver into a YUV 4:2:0 format, wherein for each region of interest base layer information is replaced by enhanced layer information.

20. The method of claim 11, wherein the receiver is a playback device.

21. At least one computer readable medium for encoding video frames having instructions stored therein that, in response to being executed on a computing device, cause the computing device to:
determine regions of interest in image data;
encode the image data into a bitstream at a base layer;
encode the regions of interest using a chroma residual of each region of interest at an enhanced layer;
combine the encoded chroma residual from the enhanced layer in a supplemental enhancement information of the bitstream of the base layer; and
transmit the bitstream to a receiver.

22. The at least one computer readable medium of claim 21, wherein the regions of interest are encoded using a UV33 surface.

23. The at least one computer readable medium of claim 21, wherein the regions of interest are encoded based on a chroma sitting location.

24. The at least one computer readable medium of claim 21, wherein the base layer contains all information to restore the bit stream at the receiver in response to the receiver not supporting the enhanced layer.

25. The at least one computer readable medium of claim 21, wherein the regions of interest are those regions that include colorful text and sharp edges.
